(19) United States
(12) Patent Application Publication
(10) Pub. No.: US 2023/0404713 A1
(43) Pub. Date: Dec. 21, 2023

(54) SYSTEM FOR TRANSFERRING ORTHODONTIC TOOLS, KIT OF PARTS COMPRISING THE SYSTEM FOR TRANSFERRING ORTHODONTIC TOOLS AND THE USE OF THE SYSTEM AND OF THE KIT OF PARTS

(71) Applicant: Fachlabor Dr. W. Klee für grazile Kieferorthopädie GmbH, Frankfurt am Main (DE)

(72) Inventors: Felix Klee, Alzenau (DE); Behrang Mehrkam, Hanau (DE)

(21) Appl. No.: 18/320,814

(22) Filed: May 19, 2023

(30) Foreign Application Priority Data
May 20, 2022 (EP) 22174621.7

(51) Int. Cl. A61C 7/02; A61C 5/00

(52) U.S. Cl. CPC A61C 7/02; A61C 5/007

(57) ABSTRACT

The present disclosure relates to a system for transferring at least one orthodontic tool onto a target tooth surface in the upper jaw or lower jaw of a patient. Further, the present disclosure relates to a kit of parts, comprising at least one system and one orthodontic tool. Finally, the present disclosure relates to the use of a system for transferring orthodontic instruments or a kit of parts for the transfer of the at least one orthodontic tool onto a target tooth surface of a tooth in the upper jaw or lower jaw of a patient.

### BACKGROUND

### Technical Field

The present disclosure relates to a system for transferring at least one orthodontic tool onto a target tooth surface in the upper jaw or lower jaw of a patient. Further, the present disclosure relates to a kit of parts, comprising at least one system and one orthodontic tool. Finally, the present disclosure relates to the use of a system for transferring orthodontic tools or a kit of parts for the transfer of the at least one orthodontic tool onto a target tooth surface of a tooth in the upper jaw or lower jaw of a patient.

### Description of the Related Art

Transfer aids for orthodontic tools are known from the prior art. DE 20 2016 101 200 U1 discloses a control structure for the positioning of orthodontic brackets for orthodontic treatment using a positioning jig (also known as a positioning template, or template). The positioning jig has a mount, which can detachably support a bracket while it is being affixed on the tooth. The control structure has at least one opening for its positioning, which is formed similarly to the three-dimensional growth of a tooth, and a second opening with which the positioning jig is brought into an approximate position in relation to the control structure, in order to bring the bracket to the corresponding tooth surface (according to the orthodontic treatment plan). Individually adapted jigs are provided in each case for multiple teeth. Reference codes are recorded on the jigs and the structure so that the large number of different jigs are inserted into the respective correct second openings. Such systems have the disadvantage that while all information for aligning the orthodontic tools on the tooth surfaces is contained in the transfer aids, such systems do not have a mechanism that not only unequivocally places the transfer aids, but which also ensures that the transfer aids also remain fixed in this optimized position. Further, the known systems that consist of a rail and a positioning aid take up an extremely large amount of space and cover large parts of the teeth after insertion of the transfer aid into the oral cavity of the patient. Usually, the orthodontic tools are connected to the target tooth surface in the transfer position with the aid of an adhesive. This regularly leads to a situation in which, due to an unclearly defined position of the orthodontic tool in front of the tooth surface, an unnecessarily large amount of adhesive wells up between the orthodontic tool and the tooth surface.

The systems known from the prior art still have disadvantages and leave problems unresolved.

### BRIEF SUMMARY

There is accordingly a need to overcome the disadvantages of the systems known from the prior art for transferring orthodontic tools onto teeth. In some cases, the present disclosure provides a system that clearly secures the position of the tools to be transferred, yet can also be used in a simple, space-saving manner. Further, it should be ensured that the orthodontic tools adhere to the teeth as well as possible, and that subsequent work is reduced as far as possible.

As a result, according to a first aspect of the present disclosure, a system was found for transferring at least one orthodontic tool onto a target tooth surface in the upper jaw or in the lower jaw of a patient (also referred to as the first transfer aid), comprising at least one, in some cases precisely one, tooth splint for a plurality of teeth, adapted and arranged in order to enter into a force-fit, in some cases a force- and form-fit, pairing with at least one tooth, in some cases multiple teeth, in the upper jaw or in the lower jaw of the patient. Here, the at least one tooth splint has at least one guide, in some cases a guide channel, comprising an entry opening, and at least one template, comprising a support arm with a carrier, which is adapted and arranged to detachably hold an orthodontic tool, and a driver, in some cases with a complementary shape, which is adjusted to the guide, such as a sliding pin. Such a system is characterized in that in the region of the guide and/or the driver, the system comprises a positioning unit, which is adapted and arranged to affix the driver in the guide in a detachable, translatory manner, so that the carrier of the template is present in a predetermined position relative to the tooth splint. Accordingly, with the system according to the present disclosure, in the region of the guide and/or of the driver, a positioning unit is present which can affix the driver in the guide in a detachable, translatory manner, so that the carrier of the template can be brought into a predetermined position relative to the tooth splint. The at least one tooth splint for the plurality of teeth is expediently designed such that it produces a force-fit, in some cases a force- and form-fit, pairing with at least one tooth, in some cases multiple teeth, in the upper jaw or in the lower jaw of the patient. With the system according to the present disclosure, it is provided that the carrier can detachably hold an orthodontic tool.

Orthodontic tools in the sense of the present disclosure can for example be so-called brackets, buttons or attachments, which can serve as fixing points for wires or loops, which in turn ensure that misalignment of teeth in a set of teeth is corrected as a result of their specific form, length or physical properties. With the system according to the present disclosure, orthodontic tools can be securely transferred to the correct position, in some cases as a result of the positioning unit.

### General Description

An expedient embodiment of the system according to the present disclosure according to the first aspect of the present disclosure is characterized in that the at least one positioning unit comprises a spacer, in some cases a stop, adapted and arranged to limit the translatory movement of the driver in the guide in such a manner that the carrier of the at least one template is present at a predetermined first distance apart relative to the tooth splint. Accordingly, via the spacer, in some cases the stop, the translatory movement of the driver in the guide can be limited such that the carrier of the template is present at a predetermined first distance apart relative to the tooth splint.

The spacer is used to unequivocally set the transfer position. It has been shown that the transfer of the orthodontic tools can be conducted securely when an insurmountable barrier in the form of a spacer is provided. If the template is inserted into the guide and if it hits the spacer, the spacer securely prevents deeper insertion of the template into the guide.

With an expedient embodiment according to a second aspect of the system according to the present disclosure (also referred to as the second transfer aid), the positioning unit comprises at least one first, in some cases radial, protrusion, in some cases an axial shoulder, on the driver, and at least one first recess, in some cases on the inner surface of the guide, in some further cases of the guide channel, or at least one first, in some cases radial, protrusion, in some cases an axial shoulder, on the inner surface of the guide, in some further cases the guide channel, and the positioning unit comprises at least one first recess on the driver.

Due to the use of protrusions and recesses on the driver, which can be held on the inner surface of the guide, it has surprisingly been shown that the transfer position can be unequivocally and securely set. Due to the precise specification of the transfer position of the orthodontic tool, it has been surprisingly shown that the positioning of the tools in front of the teeth to be fitted with the orthodontic tools can be conducted significantly more quickly than with standard systems. The system according to the present disclosure further has the advantage that during transfer, compared to standard systems, significantly less adhesive wells up between the teeth to be fitted with the orthodontic tools and the orthodontic tool to be transferred. Without adhering to any theory, it is assumed that the system according to the present disclosure enables a precise positioning of the orthodontic tools. As a result, excess and in some cases, excess and hardened adhesive, does not require time-consuming removal. The use of protrusions and recesses further has the advantage that when the transfer aid is used, sensory feedback from the transfer aid to the user of the transfer aid is transmitted in the form of latching or clicking. In this way, the user clearly understands that the transfer position has been adopted.

Here, it has been shown to be advantageous that if the positioning unit comprises a spacer and protrusions and/or recesses, the corresponding protrusions and/or recesses in the guide and template latch during insertion of the driver, and at the same time, the driver hits the spacer. While the latched corresponding protrusions and recesses could be overcome or pushed against each other without the spacer by pressing too hard, the spacer has the effect that the driver can reliably not be inserted too deeply into the guide. Further, compared to the known systems, the drivers can be quickly and reliably mounted on the tooth splint using this system. Post-adjustment is no longer required.

With the system according to the present disclosure according to the second aspect of the present disclosure, during the pairing, in some cases during the engagement of the complementary shapes, of the first protrusion and the first recess, the carrier of the at least one template is present at the first distance apart in a transfer position relative to a predetermined tooth that is assigned or assignable to the template.

The transfer position is an alignment of the system in which the carrier of the template is positioned in front of the target tooth surface such that an orthodontic tool to be transferred with it, e.g., a bracket, can be glued to the target tooth surface. The first distance is here in some cases selected such that the distance apart from an orthodontic tool detachably present in the carrier, in some cases from the surface to be glued of the orthodontic tool, to the tooth surface is in the range from 0.1 mm to 1 mm, in some cases in the range from 0.2 to 1 mm, and in some further cases in the range from 0.3 to 0.8 mm.

Alternatively, with the system according to the present disclosure, according to the second aspect of the present disclosure, during the pairing, in some cases during the engagement of the complementary shapes, of the first protrusion and the first recess, the carrier of the at least one template is present at the second distance apart in a holding position relative to a predetermined tooth that is assigned or assignable to the template.

Here, the holding position is an alignment of the system in which the carrier of the template is positioned far in front of the target tooth surface such that an unwanted gluing of an orthodontic tool that is detachably present in the carrier to the target tooth surface can be prevented. Here, the second distance is the distance apart from the carrier to the corresponding target tooth surface in the holding position. The second distance is thus greater than the first distance. Here, the second distance is in some cases selected such that the distance from an orthodontic tool that is detachably present in the carrier, in some further cases from the surface to be glued of the orthodontic tool, to the tooth surface is at least 4 mm, in some cases at least 6 mm, and in some further cases not above 20 mm, and in some even further cases, not above 10 mm, for example in the range of 4 to 8 mm.

According to a third aspect of the system according to the present disclosure (also referred to as the third transfer aid), in relation to the entry opening, on the other side of the at least one first protrusion, at a distance herefrom, the positioning unit comprises a second protrusion, in some cases an axial shoulder, in some further cases on the inner surface of the guide, in some even further cases of the guide channel, or on the other side of the at least one first recess, at a distance herefrom, the positioning unit comprises at least one second recess, in some cases on the inner surface of the guide, in some further cases of the guide channel.

With the system according to the present disclosure, according to the third aspect of the present disclosure, during the pairing, in some cases during the engagement of the complementary shapes, of the first protrusion or recess of the driver and the first protrusion or recess of the guide, the carrier of the at least one template is present at the second distance apart in a holding position relative to a predetermined tooth that is assigned or assignable to the template.

Alternatively, with the system according to the present disclosure, according to the third aspect of the present disclosure, during the pairing, in some cases during the engagement of the complementary shapes, of the first protrusion or recess of the driver and the second protrusion or recess of the guide, the carrier of the at least one template is present at the first distance apart in a transfer position relative to a predetermined tooth that is assigned or assignable to the template.

According to a fourth aspect of the system according to the present disclosure (also referred to as the fourth transfer aid), in relation to the support arm, on the other side of the at least one first protrusion, at a distance herefrom, the positioning unit comprises at least one second protrusion, in some cases an axial shoulder, in some further cases on the driver, or in relation to the support arm, on the other side of the at least one first recess, at a distance herefrom, the positioning unit comprises at least one second recess, in some cases on the driver.

With the system according to the present disclosure, according to the fourth aspect of the present disclosure, during the pairing, in some cases during the engagement of the complementary shapes, of the first protrusion or recess of the driver and the first protrusion or recess of the guide, the carrier of the at least one template is present at the second distance apart in a holding position relative to a predetermined tooth that is assigned or assignable to the template.

Alternatively, with the system according to the present disclosure, according to the fourth aspect of the present disclosure, during the pairing, in some cases during the engagement of the complementary shapes, of the second protrusion or recess of the driver and the first protrusion or recess of the guide, the carrier of the at least one template is present at the first distance apart in a transfer position relative to a predetermined tooth that is assigned or assignable to the template.

Due to the provision of two protrusions or recesses on the driver or on the guide according to the third and fourth aspect of the present disclosure, the template can be present in a holding position or in a transfer position as required. Thus, the templates and, where necessary, the tools affixed therein can already be arranged movably in the holding position or transfer position in the tooth splint guide assigned to them at the point in time of delivery to the user of the system, in some cases the orthodontist. It has been shown that in this way, the templates and, where necessary, the orthodontic tools detachably affixed therein can be held in the tooth splint in a reliable manner. To glue the orthodontic tools, the templates can be moved from the holding position into the transfer position.

Due to the use of protrusions and recesses on the driver or the guide, such that they can be held on the inner surface of the guide or the surface of the driver, it has surprisingly been shown that the transfer position and/or the holding position can clearly and securely be set. The use of protrusions and recesses further has the advantage that during use of the transfer aid, a sensory feedback is transmitted from the transfer aid to the user of the transfer aid in the form of latching or clicking. Thus, the user clearly understands that the transfer position has been adopted, in some cases in cases when they have moved the template from the holding position into the transfer position.

According to a fifth aspect of the system according to the present disclosure (also referred to as the fifth transfer aid), in relation to the entry opening, on the other side of the at least one first protrusion, at a distance herefrom, the positioning unit comprises at least one second protrusion, in some cases an axial shoulder, in some further cases on the inner surface of the guide, in some even further cases of the guide channel, or in relation to the entry opening, on the other side of the at least one first recess, at a distance herefrom, the positioning unit comprises at least one second recess, in some cases on the inner surface of the guide, in some further cases of the guide channel. Further, according to the fifth aspect of the system according to the present disclosure, in relation to the support arm, on the other side of the at least one first protrusion, at a distance herefrom, the positioning unit comprises at least one second recess, in some cases an axial shoulder, in some further cases on the driver, or in relation to the support arm, on the other side of the at least one first recess, at a distance herefrom, the positioning unit comprises at least one second recess, in some cases on the driver.

With the system according to the present disclosure, according to the fifth aspect of the present disclosure, during the pairing, in some cases during the engagement of the complementary shapes, of the first protrusion or recess of the driver and the first protrusion or recess of the guide, the carrier of the at least one template is present at the second distance apart in a holding position relative to a predetermined tooth that is assigned or assignable to the template.

Alternatively, with the system according to the present disclosure, according to the fifth aspect of the present disclosure, during the pairing, in some cases during the engagement of the complementary shapes, of the second protrusion or recess of the driver and the first protrusion or recess of the guide, the carrier of the at least one template is present at the first distance apart in a transfer position relative to a predetermined tooth that is assigned or assignable to the template.

According to a further alternative, with the system according to the present disclosure, according to the fifth aspect of the present disclosure, during the pairing, in some cases during the engagement of the complementary shapes, of the first protrusion or recess of the driver and the second protrusion or recess of the guide, the carrier of the at least one template is present at the first distance apart in a transfer position relative to a predetermined tooth that is assigned or assignable to the template.

In an expedient embodiment of the system according to the present disclosure, according to the first, second, third, fourth or fifth aspect of the present disclosure, the spacer is formed as one piece with the template, in some cases with the driver or the guide, in some other cases the tooth splint. Such systems reduce the complexity of the transfer aid and guarantee simple, reliable use.

In a further expedient embodiment of the system according to the present disclosure, according to the first, second, third, fourth or fifth aspect of the present disclosure, the at least one first protrusion or recess and/or the at least one second protrusion or recess is formed as one piece on the template, in some cases the driver, or on the guide, in some cases the tooth splint. Alternatively or in addition, it can be provided that the at least one recess or protrusion and the at least one second recess or protrusion is formed as one piece on the guide, in some cases the tooth splint, or on the template, in some cases the driver. Such systems reduce the complexity of the transfer aid and guarantee simple, reliable use.

In a further expedient embodiment of the system according to the present disclosure, according to the first, second, third, fourth or fifth aspect of the present disclosure, the carrier has a support area directed onto the target tooth surface with a support notch for the force-fit, in some cases force- and form-fit, retention of the orthodontic tool, in some other cases a support notch with a shape that complements the orthodontic tool. Here, the support notch is adapted to the orthodontic tool being used, so that it can be held in the support notch.

Due to the support notch, the orthodontic tools can be reliably reversibly held in the carrier. Following final affixing of the orthodontic tools on the tooth surface, the templates can be detached from the orthodontic tools and removed from the mouth of the patient. Further, even before the system is delivered to its user, it is possible to also hold the orthodontic tools in the support notches provided for this purpose in the template. This has the advantage that fewer work steps are required than with known systems in order to use the system for transferring orthodontic tools, and thus, fewer error sources can arise.

In an expedient embodiment of the system according to the present disclosure, according to the first, second, third, fourth or fifth aspect of the present disclosure, the support notch has at least one support notch protrusion, in some cases at least two support notch protrusions that are located opposite, in some further cases transverse, in some even further cases perpendicular, to an in some cases linear movement direction of the template, for the force-fit, in some cases force- and form-fit, retention of the orthodontic tool, wherein in some cases, the at least one support notch protrusion extends into the carrier transverse to a movement direction of the template. The support notch protrusions help to even more securely prevent the orthodontic tools from falling out.

Such systems according to the first, second, third, fourth or fifth aspect of the present disclosure are practical with which the support notch fully or partially receives the support area. In this way, it is possible for the support notch to also receive those orthodontic tools whose dimensions are larger than the support area. For example, it is possible for the orthodontic tool to have an extension, which protrudes over the edge of the support area in a slot provided for the purpose, which comprises the support area and parts of the carrier.

In a further expedient embodiment of the system, according to the first, second, third, fourth or fifth aspect of the present disclosure, the guide and the tooth splint comprise resp. are a plastic component produced as one piece.

In an expedient embodiment of the system, according to the first, second, third, fourth or fifth aspect of the present disclosure, the template is movably held on the tooth splint, in some cases on the guide, in some cases in a translatory manner in a longitudinal direction, wherein the movement of the template occurs into the guide and out of the guide along two axes, X and Y, running essentially parallel to each other, wherein the axis X is the longitudinal axis of the guide and the axis Y is the direction of insertion of the tools W into the support notch. Such a design ensures that the template can be easily pulled off from the orthodontic tool after it has been adhered to a corresponding tooth. If the axes do not, as described above, run essentially parallel to each other, a tipping of the template with the orthodontic tool may occur and pulling off would not be possible, or would only be possible with great difficulty, or subjecting the orthodontic tool to high stress.

In an expedient embodiment of the system, according to the first, second, third, fourth or fifth aspect of the present disclosure, the template and/or the guide have a round or polygonal, in some cases quadrangular, profile, wherein in some cases, the shape of the profiles of the template and the guide correspond to each other. Polygonal, in some cases quadrangular, profiles have been proven to be practical. In this way, the alignment of the template for insertion into the guide can thus be essentially specified.

In another expedient embodiment of the system according to the present disclosure, according to the first, second, third, fourth or fifth aspect of the present disclosure, the driver, which is in some cases present in the form of a pin, comprises at least two side arms, which are spaced apart from each other, in some cases lengthwise, in some further cases spring-elastic, which extend in the direction of the support arm from the end of the driver located opposite the support arm and which in some cases merge with each other as one piece. Here, the protrusions and/or recesses can be provided on the surface of the side arm pointing to the inner side of the guide.

Such embodiments have also been proven to be expedient with which the driver has a diameter on the end opposite the support arm or in the region of the end opposite the support arm, which is greater than the diameter of the guide, and wherein the at least two side arms are spaced apart from each other to such an extent that they are movable towards each other, so that the driver is insertable into the guide, in some cases until it reaches the transfer position.

It has surprisingly been shown that through the use of side arms, the insertion of the template into the guide is made easier. Due to the elastic design of the side arms, these can adapt to the opening of the guide. For example, during insertion into the guide, the side arms can be slightly pressed together. As soon as the corresponding protrusions and recesses engage with each other, the side arms automatically move back to their initial state, due to their elastic form.

It is also possible that with systems according to the first, second, third, fourth or fifth aspect of the present disclosure, the guide and the template have a coding means, so that an unequivocal allocation of the template to a corresponding guide is possible. In some cases, it may be necessary to allocate templates to corresponding guides. To enable this to be clearly done, coding means, such as those in the form of numbers, help with the insertion of a template into a guide with a corresponding coding means.

With systems according to the first, second, third, fourth or fifth aspect of the present disclosure, which have a support notch protrusion, it is further suitable that the at least one support notch protrusion comprises or consists of a second plastic material with a Shore hardness D that is equal to or less then, in some cases less than, the Shore hardness D of the carrier.

According to a sixth aspect of the present disclosure, the problem that forms the basis of the present disclosure is further resolved by a system for transferring orthodontic tools onto a target tooth surface, in some cases according to any one of the preceding aspects, comprising at least one tooth splint, wherein the at least one tooth splint comprises a form-fit holding region, the shape of which is adapted to at least one predetermined tooth surface, such as tooth inner sides and/or tooth outer sides and/or chewing surfaces, of multiple teeth, wherein the form-fit holding region is adapted and arranged to cover the surface of the predetermined tooth surface, in some cases partially or fully; and at least one holding bridge opposite the form-fit holding region, which is adapted and arranged to be engageable in contact with at least one other tooth surface, in some cases in a force- and form-fit manner.

It has surprisingly been shown that when holding bridges are used, space-saving tooth splints can be produced. This in some cases has the advantage that less space is taken up by the tooth splint in the oral cavity of the patient. Thus, more space for using the system for transferring orthodontic tools is made available.

Here, such embodiments of the sixth aspect of the present disclosure are suited in which the at least one holding bridge is adapted and arranged to be bringable into a force-fit touching contact with two directly adjacent teeth, in some cases in the region of an interdental space between two directly adjacent teeth in the lower jaw or the upper jaw. In this way, a force-fit touching contact with two directly adjacent teeth, in some cases in the region of an interdental space two directly adjacent teeth in the lower jaw or the upper jaw, can be produced via the holding bridge. This has the advantage that only a small number of holding bridges, in some cases only two holding bridges, in some further cases only one holding bridge, is required for attachment of the tooth splint on the teeth.

Furthermore, such embodiments of the sixth aspect of the present disclosure are suited in which the tooth splint has at least one free space, which is arranged between the at least one holding bridge and a directly adjacent further holding bridge and/or between the holding bridge and a directly adjacent form-fit region on the other tooth surface. As a result, the system according to the present disclosure for transferring orthodontic tools has the unexpected advantage that a large amount of free space is available on the tooth surface to be fitted with orthodontic tools. In this way, the orthodontic tools can be easily attached on the tooth surfaces, and subsequent work, in some cases in the form of removal of excess adhesive, is easy, in some cases easier than with systems known from the prior art.

In an expedient embodiment of the system according to the sixth aspect of the present disclosure, the tooth splint has a wall thickness of maximum 5 mm, in some cases of maximum 3 mm, and in some further cases of maximum 1 mm in the region of the predetermined tooth surface assigned to it. It has been surprisingly shown that when wall thicknesses of maximum 1 to 5 mm are used, space-saving tooth splints can be produced. This in some cases has the advantage that less space is taken up by the tooth splint in the oral cavity of the patient. Thus, more space for using the system for transferring orthodontic tools is made available.

In a further expedient embodiment of the system according to the sixth aspect of the present disclosure, the guide in the region of the predetermined tooth surface assigned to it is attached on the surface of the tooth splint pointing away from the teeth covered by the tooth splint. The attachment of the guide in the region of the predetermined tooth surface assigned to it onto the wall thickness means that even less space is taken up in the oral cavity of the patient by the tooth splint, and even more space is made available for using the system for transferring orthodontic tools.

With systems according to the first, second, third, fourth, fifth or sixth aspect of the present disclosure, it is suitable that the tooth splint and/or the template in some cases contains and/or consists of at least one dimensionally stable first plastic material, wherein, in compliance with DIN EN ISO 868:2003-10, the at least one first plastic material has a Shore hardness D in the range of 74-93, in some cases from 83 to 86, in each case determined according to scale D.

In systems according to the first, second, third, fourth, fifth or sixth aspect of the present disclosure, such plastic materials for the first and/or the at least one second plastic material are suitable which are selected from the group consisting of polyacrylates, polyolefins, polyurethanes, polyetherketones, polyetherimides, polyesters, polycaprolactones, acrylic-butadiene-styrene-copolymers, polyamides and polylactides, wherein the plastic material in some cases is or comprises polyacrylates, in some further cases transparent polyacrylates, and in some even further cases polyacrylates of type MED610.

To produce systems according to the present disclosure according to the first, second, third, fourth, fifth or sixth aspect of the present disclosure, such methods are well suited in which the tooth splint and possibly the at least one template is produced in a computer-supported method and/or in an additive method, in some cases in a 3D printing method. Here, computer-supported methods can for example comprise CAD/CAM methods for substance-removing milling. Additive methods can in turn comprise 3D printing methods, for example. Among other things, these methods enable all components of the system according to the present disclosure according to the first, second and third aspect of the present disclosure to be produced in one method step.

According to a seventh aspect of the present disclosure, a kit of parts, comprising at least one system according to the first, second, third, fourth, fifth or sixth aspect of the present disclosure, and at least one orthodontic tool (W), in some cases brackets, buttons and/or attachments, is disclosed.

According to a suitable embodiment of the kit of parts, the distance between the part of the orthodontic tool to be glued to the target tooth surface in the transfer position and the target tooth surface is in the range from 0.1 mm to 1 mm, in some cases in the range from 0.2 to 1 mm, and in some further cases in the range from 0.3 to 0.8 mm. By contrast, in the holding position, the distance between the part of the orthodontic tool, in some cases the surface of the orthodontic tool to be glued, which is to be glued to the target tooth surface, and the target tooth surface, is in some cases maximum 20 mm, in some other cases maximum 10 mm, and in even some further cases in the range of 3 to 8 mm or 4 to 8 mm. This distance is accordingly furthermore in some cases at least 3 mm and in some further cases at least 4 mm.

An eighth aspect of the present disclosure discloses the use of a system for transferring at least one orthodontic tool onto a target tooth surface in the upper jaw or in the lower jaw of a patient according to the first, second, third, fourth, fifth or sixth aspect of the present disclosure, or of a kit of parts according to the present disclosure for transferring the at least one orthodontic tool onto a surface of a tooth in the upper jaw or in the lower jaw of a patient, or multiple orthodontic tools onto the respective surface of multiple teeth in the upper jaw or lower jaw of a patient.

Further features and advantages of the present disclosure are disclosed in the description below, and are explained in the exemplary embodiments of the present disclosure with reference to schematic drawings, without limiting the present disclosure as a result.

### BRIEF DESCRIPTION OF THE DRAWINGS

In the drawings,

FIG. 1 shows a view of an embodiment of a tooth splint according to the sixth aspect of the system according to the present disclosure for transferring orthodontic tools,

FIG. 2 shows a profile of a first embodiment of the system according to the present disclosure for transferring orthodontic tools,

FIG. 3 shows a profile of an embodiment according to the second aspect of the system according to the present disclosure for transferring orthodontic tools,

FIG. 4 shows a profile of a further embodiment according to the second aspect of the system according to the present disclosure for transferring orthodontic tools,

FIG. 5 shows a profile of an embodiment according to the third aspect of the system according to the present disclosure for transferring orthodontic tools in the transfer position,

FIG. 6 shows a profile of an embodiment according to the third aspect of the system according to the present disclosure for transferring orthodontic tools in the holding position,

FIG. 7 shows a profile of an embodiment according to the fifth aspect of the system according to the present disclosure for transferring orthodontic tools in the transfer position,

FIG. 8 shows a profile of an embodiment according to the fifth aspect of the system according to the present disclosure for transferring orthodontic tools in the holding position,

FIG. 9 shows a profile of the carrier of the system according to the present disclosure for transferring orthodontic tools in an enlarged view, and

FIG. 10 shows a view of an embodiment of the template according to the present disclosure.

In the description below of exemplary embodiments of the present disclosure with reference to the figures, the same or similar reference numerals are used for the same or similar components for ease of readability.

### DETAILED DESCRIPTION

Orthodontic tools are used to correct misalignments of single or multiple teeth in the jaw of a patient. For this purpose, mechanical force is provided by a tensioning component. Usually, the force of a tensioning component is applied to multiple teeth in the lower jaw or in the upper jaw, in order to force the teeth into a desired position. This force is transferred by the tensioning component onto multiple teeth using orthodontic tools. For an efficient, correctly directed provision of the force to the teeth, a correct positioning of the orthodontic tools is crucial. The orthodontic tools must therefore be regularly adjusted and positioned on different teeth, taking into account the features of the patient's individual jaw. Here, secure and precise affixing of the orthodontic tool on the tooth by the doctor conducting the treatment is of importance.

A person skilled in the art will understand that the following embodiments, which as an example relate to a tooth splint 2 for the lower jaw, apply accordingly to the upper jaw. Further, a person skilled in the art will understand that instead of the embodiments described below, with which the target tooth surface is provided on the tooth front side, alternatively, the target tooth surface can be provided on the rear sides of the teeth.

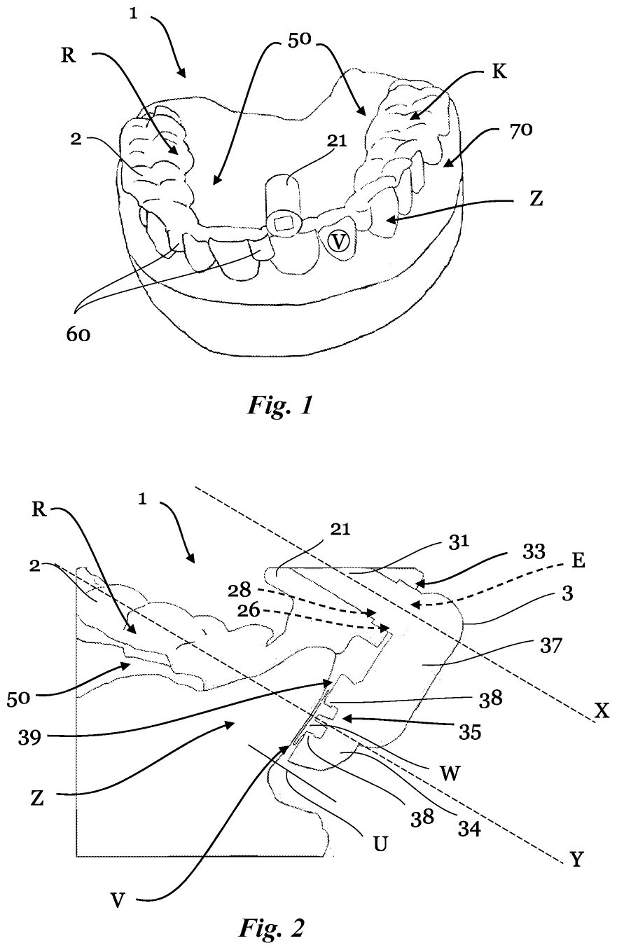

FIG. 1 shows an exemplary view of an embodiment of a tooth splint 2 of the system according to the present disclosure for transferring at least one orthodontic tool W onto a target tooth surface in the upper jaw or in the lower jaw of a patient according to the fifth aspect of the present disclosure. For this purpose, the tooth splint 2 is, for example, affixed to a model of a human lower jaw.

As components, a system 1 for transferring an orthodontic tool W comprises a tooth splint 2 with a guide 21 and at least one template 3 (not shown) which is adjusted to the guide 21, with a carrier 34 (not shown) for holding the orthodontic tool W (not shown).

The shape of the exemplary tooth splint 2 shown in FIG. 1 is adapted to the outer contour of the teeth in the lower jaw 70 of the patient. The tooth splint 2 essentially covers the rear side R of the teeth in full. In addition, the tooth splint 2 can fully cover the chewing surface K of the teeth Z, at least in portions. The portions of the tooth splint adapted and arranged for the force-fit, in some cases force- and form-fit, and surface coverage of the teeth can be described as form-fit holding regions 50. The target tooth surface V is free of a surface coverage by the tooth splint 2.

For a precise fit of the tooth splint 2 and in some cases of the form-fit holding regions it can be provided that the tooth splint 2 is produced in a computer-supported method, in some cases a 3D printing method. For this purpose, a computer-based three-dimensional model of the jaw can initially be recorded, directly on the jaw or with the aid of a mold taken of the jaw. On the basis of the three-dimensional model of the jaw, in a computer-support method, a cover-like fit for the tooth splint 2 can be determined. The tooth splint can subsequently be calculated using a computer-supported method on the basis of the cover-like fit, and then produced.

For the force-fit, in some cases force- and form-fit pairing, the tooth splint 2 shown has holding bridges 60 in the region of the target tooth surface V of the teeth Z, which is to be fitted with the orthodontic tools W. The holding bridges 60 are arranged opposite the portion of the tooth splint 2 for surface coverage of the rear side of the tooth R. The holding bridges 60 act together with the form-fit holding region 50 in order to hold the tooth splint in a predetermined position. For this purpose, the holding bridges 60 are designed such that the holding bridges are connected in a force-fit, in some cases a force- and form-fit, manner with parts of the front sides of the tooth of two adjacent teeth in a jaw, and also with parts of the interdental space formed by two adjacent teeth. The use of the holding bridges leads to a reduction in material for producing the tooth splint that can be inserted in a force-fit, in some cases force- and form-fit manner, and at the same time, the front side of the tooth V is essentially freely accessible for the orthodontic tools to be positioned. Due to this material reduction, less space is taken up by the tooth splint in the oral cavity of the patient. As a result, the tooth splint can easily be inserted into the mouth of the patient, and any work required in the oral cavity of the patient following insertion of the tooth splint is made easier. With standard tooth splints, compared to the tooth splint according to the present disclosure, larger parts of the tooth contours are enclosed by material in order to enable a form- and force-fit positioning of the tooth splint.

Further, the tooth splint (2) shown in FIG. 1 has a guide 21 that is formed as one piece with the tooth splint 2, which can hold a template 3 (not shown in FIG. 1). In the example shown, the tooth splint 2 and the guide 21 are produced in one or more sequential steps in an additive production method. With generative production methods, the wall thickness of the plastic components, comprising the tooth splint 2 and the guide 21, are minimized to the required dimension, so that the tooth splint 2 and the guide 21 take up a small amount of space in the oral cavity of the patient. This makes it easier for the doctor conducting the treatment to access the oral cavity, for secure and precise affixing of the orthodontic tools.

In an embodiment of the tooth splint 2 not shown, it is also feasible that for each tooth to be fitted with an orthodontic tool according to the therapy plan, a guide 21 is provided on the tooth splint 2. Here, the space-saving design of the tooth splint makes it possible for all teeth in a jaw to also be fitted with orthodontic tools W. In an embodiment of the system 1 not shown, the tooth splint can be designed such that the holding bridges 60 engage with the rear side of the tooth R and the form-fit holding region 50 lies on the target tooth surface V with a complementary shape. As a result, the orthodontic tools W can easily be positioned on the rear side of the tooth R.

FIG. 2 further shows a profile of a system for transferring at least one orthodontic tool onto a target tooth surface in the upper jaw or in the lower jaw of a patient. Unlike in FIG. 1, a template 3 is inserted into the guide 21 using a sliding pin 31 that has a shape complementary to the guide 21. Here, the predetermined transfer position U shown in FIGS. 2, 3, 5, 7 and 9, is defined, in the case of FIG. 2 by a positioning unit, which comprises just one spacer 33. The spacer 33 supports the correct positioning of the orthodontic tool W and can also prevent the template 3 from being inserted too deeply into the guide 21. In the embodiment of the spacer 33 shown in FIGS. 2 to 9, said spacer is designed such that the guide 21 has a larger diameter in the region of its first opening 26 than in the region of its second opening 28. If the template 3 is inserted into the guide 21 in a translatory manner, the template hits the guide 21 in the region of the spacer 33 due to its outer shape. This ultimately prevents further insertion of the template 3 into the guide 21.

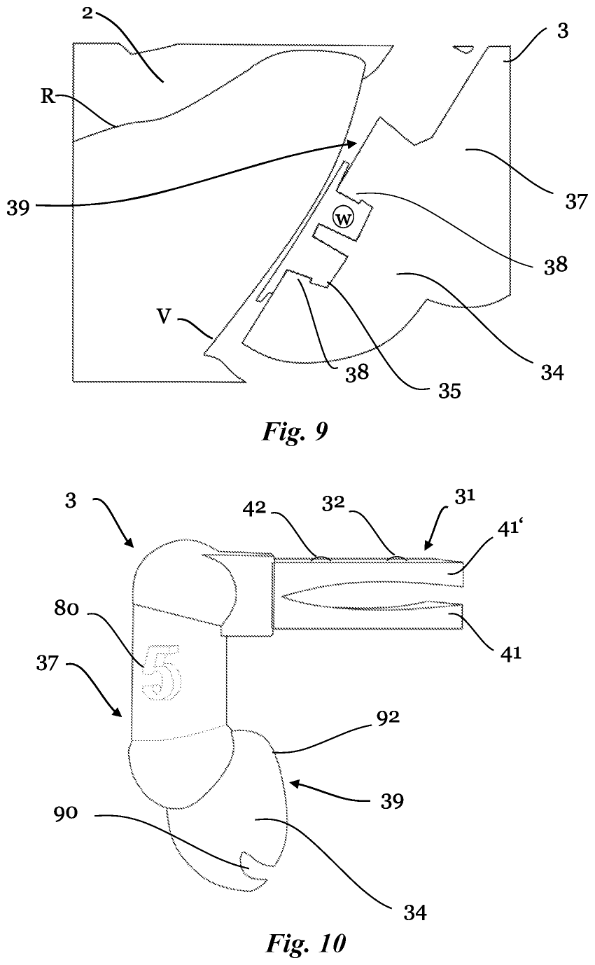

The template 3 further has a support arm 37 and a carrier 34, which is adapted and arranged to hold an orthodontic tool W in front of the target tooth surface V. This is achieved in that the carrier 34 has a support notch 35 with a complementary shape on its support area 39 for the form- and force-fit retention of the orthodontic tool W. The support notch 35 is here designed such that the orthodontic tool W can be held in the support notch by a clamping force. For the even better detachable affixing of the orthodontic tool W, in the example shown in FIGS. 2 and 9, the support notch 35 has two support notch protrusions 38. These support notch protrusions 38 permit a detachable latching of the orthodontic tool W in the support notch 35. The latching mechanism is here also optimized in that the support notch protrusions 38 can be made of a plastic material, which has a lesser Shore hardness D than the rest of the carrier 34. In this way, less force is required in order to create a latching of the orthodontic tool W in the support notch 35. With an embodiment not shown of the support notch 35, it is also feasible that just one support notch protrusion 38 can be provided.

FIG. 9 shows the system 1 already shown in FIG. 2 in an enlarged view.

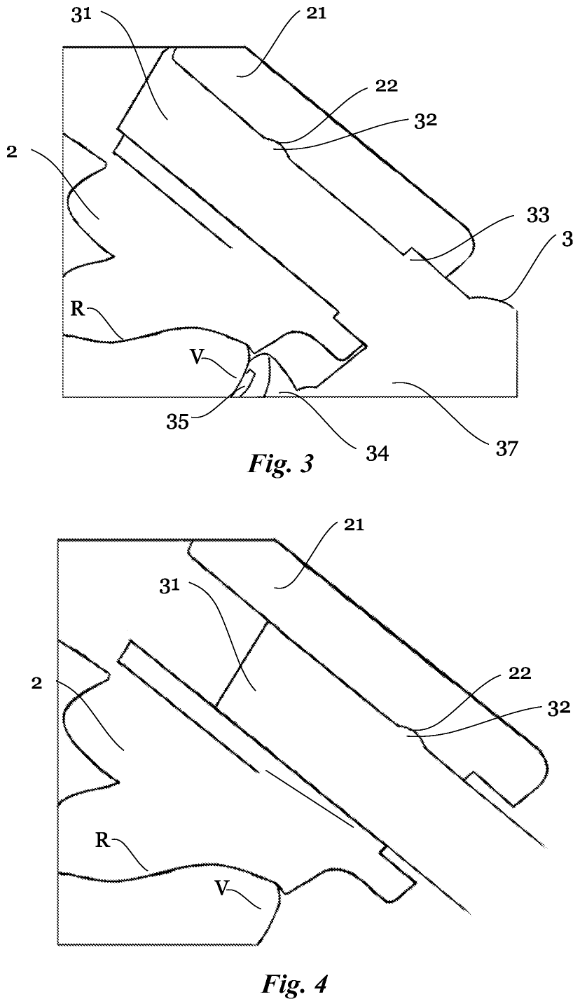

FIG. 3 further shows a profile of a system for transferring at least one orthodontic tool onto a target tooth surface in the upper jaw or in the lower jaw of a patient according to the second aspect of the present disclosure. FIG. 3 also shows the system 1 already shown in FIG. 2, wherein the positioning unit further has an axial shoulder 32 on the sliding pin 31 and a recess 22 on the inner surface of the guide 21, wherein the protrusion has been received by the recess with a complementary shape on an inner surface of the guide 21. The pairing of the axial shoulder 32 with the recess 22 ensures that the template 3 remains precisely in its transfer position U. With the immobilization, the distance between the orthodontic tool W and the target tooth surface V and thus indirectly the layer thickness of the adhesive between the bracket W and the target tooth surface V can be clearly and unchangeably determined. With standard systems, precisely the position of the orthodontic tool W is not unchangeably and clearly determinable. With the system according to the present disclosure, an efficient adhesion agency is achieved. Here, it is also ensured that not too much adhesive can emerge between the orthodontic tool W and the side of the tooth to be fitted with the orthodontic tool W, since the transfer position U can be clearly defined due to the immobilization. In this way, it is effectively prevented that excess adhesive needs to be removed, in some cases excess hardened adhesive. In an embodiment not shown, it can also be provided that the recess is formed on the surface of the sliding pin 31, and the axial shoulder is formed on the inner surface of the guide 21.

The embodiment of the system shown in FIG. 4 according to a second aspect of the present disclosure differs from the embodiment shown in FIG. 3 in that the protrusion 32 and the recess 22 are designed such that after the protrusion 32 has been received by the recess 22 in a complementary shape on an inner surface of the guide 21, the system is in the holding position.

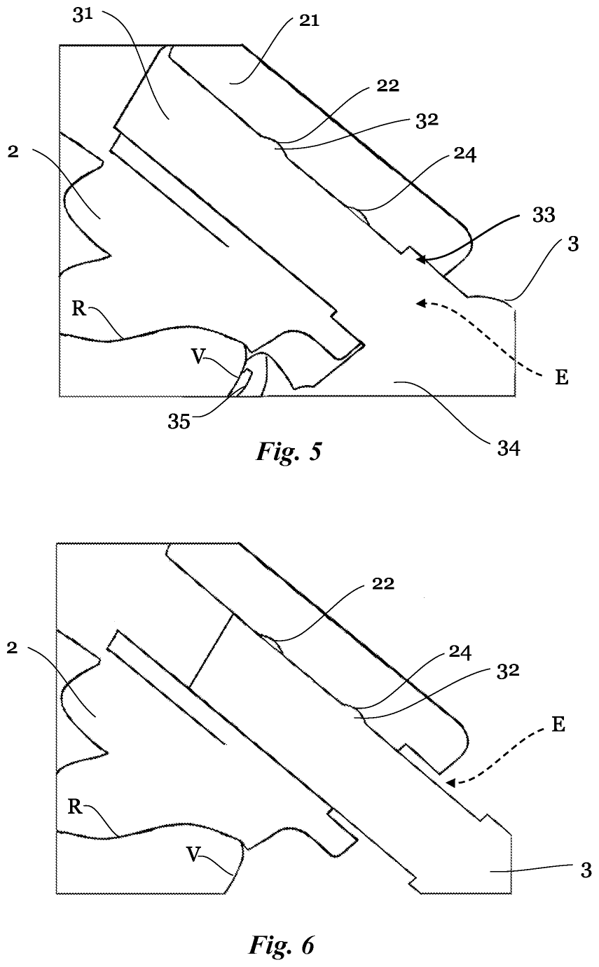

FIG. 5 further shows a profile of a system for transferring at least one orthodontic tool onto a target tooth surface in the upper jaw or in the lower jaw of a patient according to the third aspect of the present disclosure. The system shown in FIG. 5 differs from the system shown in FIG. 3 in that in relation to the entry opening E, on the other side of the recess 22, at a distance herefrom, the positioning unit comprises a second recess 24 on the inner surface of the guide. The pairing of the axial shoulder 32 with the recess 22 ensures that the template 3 remains precisely in its transfer position U. In this transfer position, the first distance between the carrier 34 and the tooth assigned to this carrier 34 is created. FIG. 6 here shows a system that is essentially identical to that in FIG. 5, with the difference that the system now precisely keeps the template 3 in its holding position H due to the pairing of the axial shoulder 32 with the recess 24. In this holding position, the second distance between the carrier 34 and the tooth assigned to this carrier 34 is created. As a result, the distance between the recess 22 and the recess 24 of the guide 21 can be regarded as the difference between the first and second distance. The first distance from the driver to the target tooth surface is here in some cases to be selected such that the distance between a surface to be glued of an orthodontic tool and the target tooth surface V in some cases lies in the range of 0.1 mm to 1 mm. This distance between a surface to be glued of an orthodontic tool in front of the target tooth surface V here corresponds to the gap recognizable in FIG. 2 between the orthodontic tool W and the target tooth surface V.

In the holding position H (FIG. 6), it is possible as shown, for example, to fully compile the system 1 before delivery to the user, so that the tooth splint 2 can be dispatched with the already inserted templates 3 and the at least one orthodontic tool W attached to them. This also has the advantage that the user does not need to ensure that the respective templates are assigned to the respective corresponding guides, so that the teeth to be corrected can also be straightened during later treatment of the teeth. The pairing of the axial shoulder 32 with the recess 24 ensures that the template 3 cannot fall out of the tooth splint 2 at any time. The user therefore only needs to insert the system 1 as delivered into the mouth of the patient, and if, for example, the adhesive to bond the orthodontic tool W with the front surface of the tooth V has already been applied onto the at least one orthodontic tool W, they only need to press the template 3 out of its holding position H into the transfer position U (FIG. 4). The steps of inserting the tooth splint 2 and pressing in of the template 3, and if necessary, the preliminary application of the adhesive, are here the only necessary steps in order to bring the orthodontic tool W into its final position in front of the front side of the tooth V. No further setting of the position of the orthodontic tool W is required.

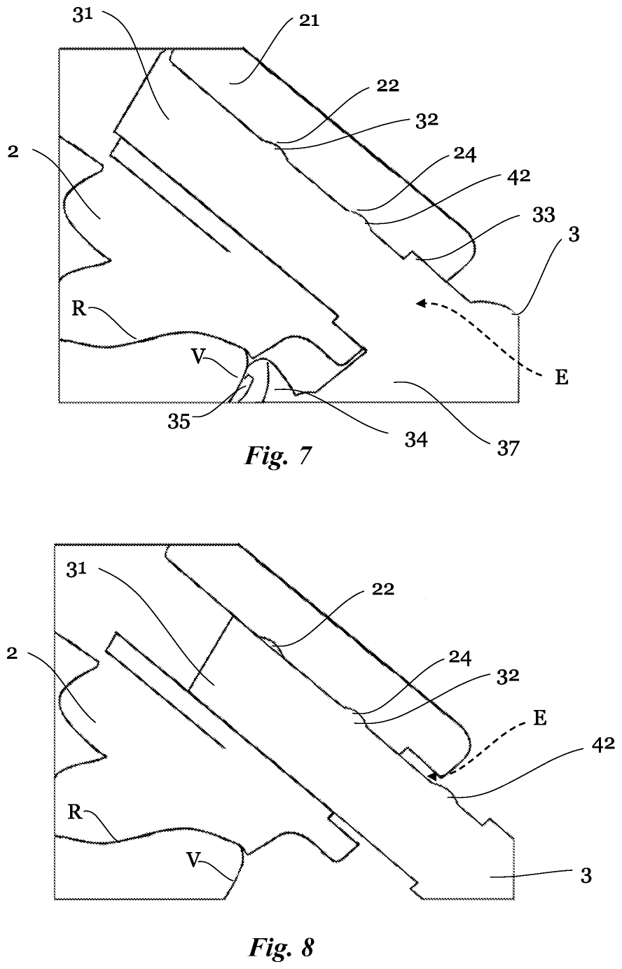

FIG. 7 further shows a profile of a system for transferring at least one orthodontic tool onto a target tooth surface in the upper jaw or in the lower jaw of a patient according to the fifth aspect of the present disclosure. The system differs from the system shown in FIG. 5 in that in relation to the support arm 37, the positioning unit comprises at least one second protrusion 42 on the other side of the at least one first protrusion 32. The pairing of the axial shoulder 32 with the recess 22 and the simultaneous pairing of the axial shoulder 42 with the recess 24 ensure that the template 3 remains precisely in its transfer position U. FIG. 8 shows the same system as in FIG. 7, although here, there is just one pairing of the axial shoulder 32 with the recess 24, while the recess 22 and the protrusion 42 are unpaired. The system is thus in the holding position H.

FIG. 10 shows an embodiment of the template 3, wherein in the region of the guide (not shown), the template 3 comprises two side arms 41, 41′, which are spaced apart from each other lengthwise, wherein the two side arms 41, 41′ merge with each other as one piece in the direction of the support arm 37. Here, the side arms 41, 41′ are a component of the driver 31 or form said driver. FIG. 10 shows the driver 31 in its basic state. In the embodiment shown, the protrusions 32, 42 are provided on the surface of the side arm 41′ pointing towards the inner side of the guide 21. It is also feasible for the protrusions to be present on the side arm 41 or simultaneously on both side arms. The corresponding recesses on the inner side of the guide are not shown. The side arms 41, 41′ are adapted and arranged to be moved towards or away from each other in a dimensionally elastic manner. In this way, they can adapt to the shape of the guide channel of the guide 21, which makes insertion of the template into the guide channel easier. FIG. 10 also shows an embodiment of the carrier 24 with which the support notch 35 partially receives the support area 39. Here, the support notch breaks through the support area edge 92, so that an open space 90 is created. The open space offers space for parts of the orthodontic tools, which due to their spatial expansion extend up to the support area edge 92 or protrude over it. FIG. 10 also shows the optional coding means 80 in the form of a number on the support arm 37 of the template 3. A corresponding coding means in the form of the same number can be provided on the surface of the guide, so that a confusion of the template 3 and a corresponding guide 21 can be securely prevented.

The features of the present disclosure disclosed in the above description, in the claims and in the drawings can be essential both individually and in any combination required for the realization of the present disclosure in its different embodiments.

### REFERENCE SIGNS

1 System for transferring an orthodontic tool
2 Tooth splint
3 Template
4 Retainer
21 Guide
22 First recess (on guide)
22a First protrusion (on guide)
24a Second protrusion (on guide)
24 Second recess (on guide)
26 First opening
28 Second opening
31 Driver
32 First protrusion (on driver)
32a First recess (on driver)
33 Spacer
34 Carrier
35 Support notch
37 Support arm
38 Support notch protrusion
39 Support area
41, 41′ Side arm
42 Second protrusion (on driver)
42a Second recess (on driver)
50 Form-fit holding region
60 Holding bridge
70 Lower jaw
80 Coding means
90 Open space
92 Support area edge
H Holding position
U Transfer position
K Chewing surface
R Rear side of tooth
V Target tooth surface
W Orthodontic tool
X X-axis
Y Y-axis
Z Tooth

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A system for transferring at least one orthodontic tool onto a target tooth surface in the upper jaw or in the lower jaw of a patient, comprising:
at least one tooth splint for a plurality of teeth, adapted and arranged in order to enter into a force-fit pairing with at least one tooth in the upper jaw or in the lower jaw of the patient, wherein the at least one tooth splint has at least one guide comprising an entry opening, and
at least one template, comprising:
a support arm with:
a carrier, which is adapted and arranged to detachably hold an orthodontic tool, and
a driver which is adjusted to the guide,
wherein in the region of the guide and/or the driver, the system comprises a positioning unit, which is adapted and arranged to affix the driver in the guide in a detachable, translatory manner, so that the carrier of the template is present in a predetermined position relative to the tooth splint.

2. The system according to claim 1, wherein the at least one positioning unit comprises a spacer adapted and arranged to limit the translatory movement of the driver in the guide in such a manner that the carrier of the at least one template is present at a predetermined first distance relative to the tooth splint.

3. The system according to claim 1, wherein:
the positioning unit comprises at least one first protrusion on the driver, and that the positioning unit comprises at least one first recess, or
the positioning unit comprises at least one first protrusion on the inner surface of the guide, and that the positioning unit comprises at least one first recess on the driver.

4. The system according to claim 3, wherein during the pairing of the first protrusion and the first recess, the carrier of the at least one template is present at the first distance apart in a transfer position relative to a predetermined tooth that is assigned or assignable to the template.

5. The system according to claim 3, wherein during the pairing of the first protrusion and the first recess, the carrier of the at least one template is present at the second distance apart in a holding position relative to a predetermined tooth that is assigned or assignable to the template.

6. The system according to claim 3, wherein:
in relation to the entry opening, on the other side of the at least one first protrusion, at a distance herefrom, the positioning unit comprises a second protrusion, or
in relation to the entry opening, on the other side of the at least one first recess, at a distance herefrom, the positioning unit comprises at least one second recess.

7. The system according to claim 6, wherein during the pairing of the first protrusion or recess of the driver and the first protrusion or recess of the guide, the carrier of the at least one template is present at the second distance apart in a holding position relative to a predetermined tooth that is assigned or assignable to the template.

8. The system according to claim 6, wherein during the pairing of the first protrusion or recess of the driver and the second protrusion or recess of the guide, the carrier of the at least one template is present at the first distance apart in a transfer position relative to a predetermined tooth that is assigned or assignable to the template.

9. The system according to claim 3, wherein:
in relation to the support arm, on the other side of the at least one first protrusion, at a distance herefrom, the positioning unit comprises at least one second protrusion, or
in relation to the support arm, on the other side of the at least one first recess, at a distance herefrom, the positioning unit comprises at least one second recess.

10. The system according to claim 9, wherein during the pairing of the first protrusion or recess of the driver and the first protrusion or recess of the guide, the carrier of the at least one template is present at the second distance apart in a holding position relative to a predetermined tooth that is assigned or assignable to the template.

11. The system according to claim 9, wherein during the pairing of the second protrusion or recess of the driver and the first protrusion or recess of the guide, the carrier of the at least one template is present at the first distance apart in a transfer position relative to a predetermined tooth that is assigned or assignable to the template.

12. The system according to claim 3, wherein:
in relation to the entry opening, on the other side of the at least one first protrusion, at a distance herefrom, the positioning unit comprises at least one second protrusion, or
in relation to the entry opening, on the other side of the at least one first recess, at a distance herefrom, the positioning unit comprises at least one second recess,
and wherein:
in relation to the support arm, on the other side of the at least one first protrusion, at a distance herefrom, the positioning unit comprises at least one second recess, or
in relation to the support arm, on the other side of the at least one first recess, at a distance herefrom, the positioning unit comprises at least one second recess.

13. The system according to claim 12, wherein during the pairing of the first protrusion or recess of the driver and the first protrusion or recess of the guide, the carrier of the at least one template is present at the second distance apart in a holding position relative to a predetermined tooth that is assigned or assignable to the template.

14. The system according to claim 12, wherein during the pairing of the second protrusion or recess of the driver and the first protrusion or recess of the guide, the carrier of the at least one template is present at the first distance apart in a transfer position relative to a predetermined tooth that is assigned or assignable to the template.

15. The system according to claim 12, wherein during the pairing of the first protrusion or recess of the driver and the second protrusion or recess of the guide, the carrier of the at least one template is present at the first distance apart in a transfer position relative to a predetermined tooth that is assigned or assignable to the template.

16. The system according to claim 1, wherein the carrier has a support area directed onto the target tooth surface with a support notch for the force-fit retention of the orthodontic tool.

17. The system according to claim 16, wherein the support notch has at least one support notch protrusion for the force-fit retention of the orthodontic tool.

18. The system according to claim 1, wherein the template is movably held on the tooth splint wherein the movement of the template occurs into the guide and out of the guide along two axes, X and Y, running essentially parallel to each other, wherein the axis X is the longitudinal axis of the guide and the axis Y is the direction of insertion of the orthodontic tool into the support notch.

19. The system according to claim 1, wherein the template and/or the guide have a round or polygonal profile.

20. The system according to claim 1, wherein the driver comprises at least two side arms which extend in the direction of the support arm from the end of the driver located opposite the support arm, and wherein the at least two side arms are spaced apart from each other to such an extent that they are movable towards each other, so that the driver is insertable into the guide.

21. A system for transferring orthodontic tools onto a target tooth surface, comprising:
at least one tooth splint, wherein the at least one tooth splint comprises a form-fit holding region, the shape of which is adapted to at least one predetermined tooth surface of a plurality of teeth, wherein the form-fit holding region is adapted and arranged to cover the surface of the predetermined tooth surface; and
at least one holding bridge opposite the form-fit holding region, which is adapted and arranged to be engageable in contact with at least one other tooth surface.

22. The system according to claim 21, wherein the at least one holding bridge is adapted and arranged to be bringable into a force-fit touching contact with two directly adjacent teeth.

23. The system according to claim 1, wherein the at least one tooth splint comprises a form-fit holding region, the shape of which is adapted to at least one predetermined tooth surface of a plurality of teeth, wherein the form-fit holding region is adapted and arranged to cover the surface of the predetermined tooth surface; and
at least one holding bridge opposite the form-fit holding region, which is adapted and arranged to be engageable in contact with at least one other tooth surface.

24. The system according to claim 23, wherein the at least one holding bridge is adapted and arranged to be bringable into a force-fit touching contact with two directly adjacent teeth.

25. The system according to claim 1, wherein the tooth splint and/or the template contains at least one dimensionally stable first plastic material and/or consists of the same, wherein the at least one first plastic material has a Shore hardness D in the range of 74 to 93.

26. The system according to claim 1, wherein the at least one first and/or the at least one second plastic material is selected from the group consisting of polyacrylates, polyolefins, polyurethanes, polyetherketones, polyetherimides, polyesters, polycaprolactones, acrylic-butadiene-styrene-copolymers, polyamides and polylactides.

27. A kit of parts, comprising:
at least one system according to claim 1 and at least one orthodontic tool.

28. The system according to claim 1, comprising
precisely one tooth splint for a plurality of teeth or wherein tooth splint is adapted and arranged in order to enter into a force-fit pairing with multiple teeth.

29. The system according to claim 1, wherein the at least one guide is a guide channel or wherein the carrier has a complementary shape to the guide.

30. The system according to claim 3, wherein the at least one first recess is on the inner surface of the guide.

31. The system according to claim 6, wherein the axial shoulder is on the inner surface of the guide or wherein the at least one second recess is on the inner surface of the guide.

32. The system according to claim 9, wherein
the at least one second protrusion an axial shoulder; or
the at least one second recess is on the carrier.

33. The system according to claim 16, wherein the support notch has a shape that complements the orthodontic tool.

34. The system according to claim 17, wherein the at least one support notch protrusion comprises or consists of a second plastic material with a Shore hardness D that is equal or less than the Shore hardness D of the carrier.

35. The system according to claim 19, wherein the shape of the profiles of the template and the guide correspond to each other.

36. The system according to claim 20, wherein the at least two side arms merge with each other as one piece or wherein the carrier is insertable into the guide until it reaches the transfer position.

37. The system according to claim 25, wherein the at least one first plastic material has a Shore hardness D in the range of 83 to 86.
